(19) United States
(12) Patent Application Publication
(10) Pub. No.: US 2024/0036327 A1
(43) Pub. Date: Feb. 1, 2024

(54) HEAD-MOUNTED DISPLAY AND IMAGE DISPLAYING METHOD

(71) Applicant: SONY INTERACTIVE ENTERTAINMENT INC., Tokyo (JP)

(72) Inventors: MITSURU NISHIBE, Chiba (JP); HARUKA IWAKI, Kanagawa (JP); KUNIAKI OE, Tokyo (JP); TAKANORI MINAMINO, Kanagawa (JP)

(21) Appl. No.: 18/358,903

(22) Filed: Jul. 25, 2023

(30) Foreign Application Priority Data
Aug. 1, 2022 (JP) 2022-122680

(51) Int. Cl. G02B 27/01; G02B 27/00; G06T 19/00

(52) U.S. Cl. CPC G02B 27/0172; G02B 27/0093; G06T 19/006; G02B 2027/0138

(57) ABSTRACT

Disclosed is a head-mounted display including a captured image acquisition section that acquires data of an image captured by a camera mounted on the head-mounted display, a display image generation section that displays the captured image on a projection plane set in a virtual three-dimensional space as a display target and draws an image obtained when the captured image is viewed from a virtual camera, to generate a display image including the captured image, a projection plane controlling section that changes the projection plane according to a situation, and an outputting section that outputs the display image.

### CROSS REFERENCE TO RELATED APPLICATION

This application claims the benefit of Japanese Priority Patent Application JP 2022-122680 filed Aug. 1, 2022, the entire contents of which are incorporated herein by reference.

### BACKGROUND

The present disclosure relates to a head-mounted display and an image displaying method that achieve stereoscopic vision.

An image displaying system that allows a user to view a target space from a free point of view has come into widespread use. For example, there has been developed a system in which a panorama screen image is displayed on a head-mounted display and an image corresponding to a line-of-sight direction of a user who is wearing the head-mounted display is displayed. When stereo images having a parallax therebetween are displayed as images for the left eye and the right eye on the head-mounted display, the user sees the displayed image as a three-dimensional image, and the sense of immersion in an image world can thus be enhanced.

Further, there has been put into practical use a technology for implementing augmented reality (AR) or mixed reality (MX) by synthesizing a computer graphics image and an image of an actual space captured by a camera mounted on a head-mounted display. Further, in a case where the captured image is displayed on a head-mounted display of the closed type, the head-mounted display is useful when the user checks the situation of the surroundings or sets a game play area.

### SUMMARY

In a case where a captured image is to be displayed on a head-mounted display on a real time basis, it leaves a problem in terms of how to generate stereo images. In particular, if a process for converting the point of view of an original captured image into the point of view of the user who sees the display world or a process for providing a parallax from the point of view of the user to the captured image is not appropriately performed, then such a situation possibly occurs that the captured image is displayed unnaturally or that it is difficult to set a play area. In some cases, there is also a possibility that the user may suffer from a poor physical condition like motion sickness.

The present disclosure has been made in view of such problems as described above, and it is desirable to provide a technology that makes it possible to appropriately display a captured image on a display such as a head-mounted display that achieves stereoscopic vision.

According to an embodiment of the present disclosure, there is provided a head-mounted display including a captured image acquisition section that acquires data of an image captured by a camera mounted on the head-mounted display, a display image generation section that displays the captured image on a projection plane set in a virtual three-dimensional space as a display target and draws an image obtained when the captured image is viewed from a virtual camera, to generate a display image including the captured image, a projection plane controlling section that changes the projection plane according to a situation, and an outputting section that outputs the display image.

According to another embodiment of the present disclosure, there is provided an image displaying method performed by a head-mounted display. The method includes acquiring data of an image captured by a camera mounted on the head-mounted display, displaying the captured image on a projection plane set in a virtual three-dimensional space as a display target and drawing an image obtained when the captured image is viewed from a virtual camera, to generate a display image including the captured image, changing the projection plane according to a situation, and outputting data of the display image to a display panel.

It is to be noted that any combination of the components described above and conversions of the representations of the present disclosure between a method, an apparatus, a system, a computer program, a data structure, a recording medium, and so forth are also effective as modes of the present disclosure.

According to the present disclosure, it is possible to appropriately display a captured image on the display such as a head-mounted display that achieves stereovision.

### BRIEF DESCRIPTION OF THE DRAWINGS

FIG. 1 is a view depicting an example of an appearance of a head-mounted display according to an embodiment of the present disclosure;

FIG. 2 is a view depicting an example of a configuration of an image displaying system according to the present embodiment;

FIG. 3 is a view schematically depicting a path of data in the image displaying system according to the present embodiment;

FIG. 4 is a view for explaining a relation between a three-dimensional space that forms a display world provided by the head-mounted display and a display image generated from a captured image in the present embodiment;

FIG. 5 is a view for explaining a problem that arises when a spherical plane is used as a projection plane in the present embodiment;

FIG. 6 is a view for explaining an example of the projection plane set in the present embodiment;

FIG. 7 is a block diagram depicting a configuration of an internal circuit of the head-mounted display according to the present embodiment;

FIG. 8 is a block diagram depicting a configuration of functional blocks of the head-mounted display according to the present embodiment;

FIG. 9 is a flow chart depicting a processing procedure for setting a play area by a play area setting section in the present embodiment;

FIG. 10 is a view exemplifying an object in a play area presented in S16 of FIG. 9;

FIG. 11 is a view for explaining a problem that arises in a case where a projection plane is made to correspond only to the floor in the present embodiment;

FIG. 12 is a view for explaining a mode in which multiple planes are combined to form the projection plane in the present embodiment;

FIG. 13 is a view for explaining a mode in which a projection plane controlling section adjusts the height of the floor surface to which the projection plane is to be made to correspond in the present embodiment; and

FIG. 14 is a flow chart depicting a procedure for displaying a see-through image in a period in which the floor surface is detected and adjusted in the present embodiment.

### DETAILED DESCRIPTION OF THE PREFERRED EMBODIMENT

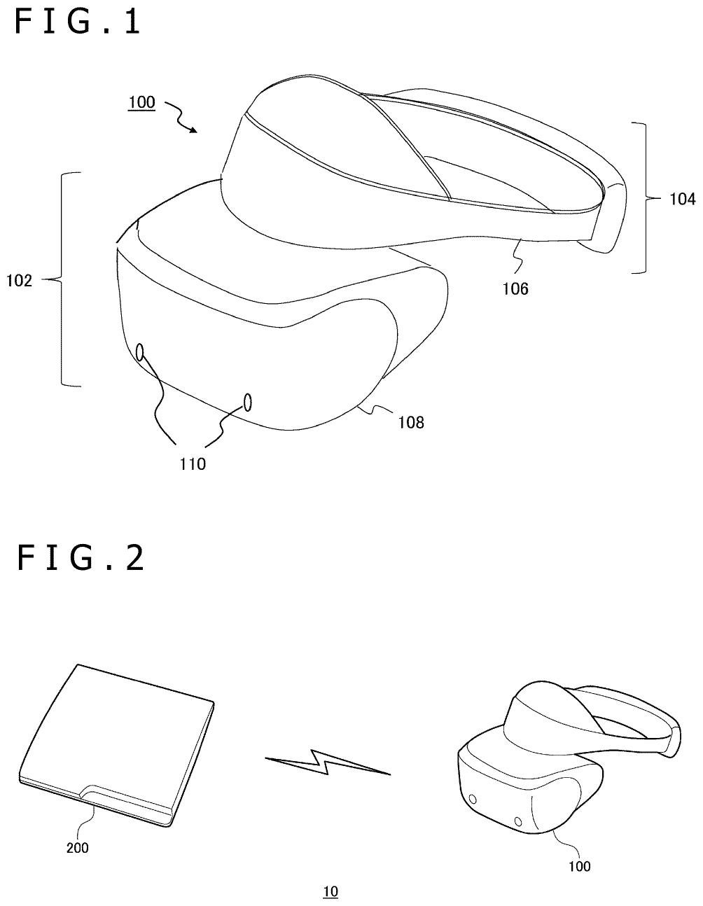

FIG. 1 depicts an example of an appearance of a head-mounted display 100. In the present example, the head-mounted display 100 includes an outputting mechanism part 102 and a mounting mechanism part 104. The mounting mechanism part 104 includes a mounting band 106 that is positioned, when the head-mounted display 100 is worn by a user, around the head of the user to fix the head-mounted display 100 to the head. The outputting mechanism part 102 includes a housing 108 shaped such that it covers both the left and right eyes of the user in a state in which the head-mounted display 100 is worn by the user. The outputting mechanism part 102 also includes a display panel provided therein to face the eyes when the head-mounted display 100 is worn.

The housing 108 further includes, in the inside thereof, eyepieces that are positioned between the display panel and the eyes of the user when the head-mounted display 100 is worn and that enlarge and display an image. The head-mounted display 100 may further include speakers or earphones at positions corresponding to the ears of the user when the head-mounted display 100 is worn. Further, the head-mounted display 100 has a motion sensor built therein. The motion sensor detects a translational movement and a rotational movement of the head of the user who is wearing the head-mounted display 100, and also detects the position and the posture of the head of the user at each time point.

The head-mounted display 100 further includes, on a front surface of the housing 108, stereo cameras 110 that capture images of the real space from left and right points of view. The present embodiment provides a mode in which a moving image being captured by the stereo cameras 110 is displayed with a small delay, so that the user can see a situation of the actual space in the direction in which the user is facing, as it is. Such a mode as described is hereinafter referred to as a “see-through mode.” For example, the head-mounted display 100 automatically enters the see-through mode in a period during which an image of content is not displayed.

Accordingly, before the content starts, after the content ends, or when the content is interrupted, for example, the user can check a situation of the surroundings without removing the head-mounted display 100. In addition, the see-through mode may be started in response to an operation explicitly performed by the user, or may be started or ended according to a situation when a play area is set, when the user goes out of the play area, or in a like case.

Here, the play area is a range of the real world within which the user who is viewing a virtual world through the head-mounted display 100 can move around, and is, for example, a range within which full movement of the user is guaranteed without colliding with an object in the surroundings. It is to be noted that, although the stereo cameras 110 are placed at a lower portion of the front surface of the housing 108 in the depicted example, the positions of the stereo cameras 110 are not limited to particular positions. Further, a camera other than the stereo camera 110 may be provided.

An image captured by the stereo camera 110 can also be used as an image of content. For example, AR or MR can be implemented by synthesizing a virtual object and a captured image such that the position, posture, and movement of the virtual object correspond to those of a real object present in the field of view of the camera, and displaying the resulting image. Further, it is possible to analyze a captured image irrespective of whether or not the captured image is to be included in the display, and decide the position, posture, and movement of an object to be drawn, by using a result of the analysis.

For example, stereo matching may be performed for a captured image to extract corresponding points of an image of a subject, and acquire the distance to the subject by the principle of triangulation. Alternatively, a known technology such as visual simultaneous localization and mapping (SLAM) may be applied to acquire the position and posture of the head-mounted display 100 and hence the position and posture of the head of the user with respect to the surrounding space. Visual SLAM is a technology for simultaneously performing self-position estimation of a movable body on which the camera is mounted and creation of an environmental map, by using a captured image. By the processes described, it is possible to draw and display a virtual world with the field of view corresponding to the position of the point of view and the direction of the line of sight of the user.

FIG. 2 depicts an example of a configuration of an image displaying system according to the present embodiment. In an image displaying system 10, the head-mounted display 100 is connected to a content processing apparatus 200 by wireless communication or an interface that establishes connection with peripheral equipment, such as a universal serial bus (USB) Type-C. The content processing apparatus 200 may further be connected to a server through a network. In this case, the server may provide an online application of a game in which multiple users can participate through the network, for example, to the content processing apparatus 200.

The content processing apparatus 200 is basically an information processing apparatus that processes content to generate a display image and that transmits the display image to the head-mounted display 100 to display the image on the head-mounted display 100. Typically, the content processing apparatus 200 specifies the position of the point of view and the direction of the line of sight of the user who is wearing the head-mounted display 100, on the basis of the position and posture of the head of the user, and generates a display image with the field of view corresponding to the specified position and direction. For example, the content processing apparatus 200 generates, while progressing an electronic game, an image representative of a virtual world that is a stage of the game, to implement virtual reality (VR).

In the present embodiment, the content to be processed by the content processing apparatus 200 is not limited to a particular one, and may implement AR or MR as described above or include display images generated in advance as in a movie.

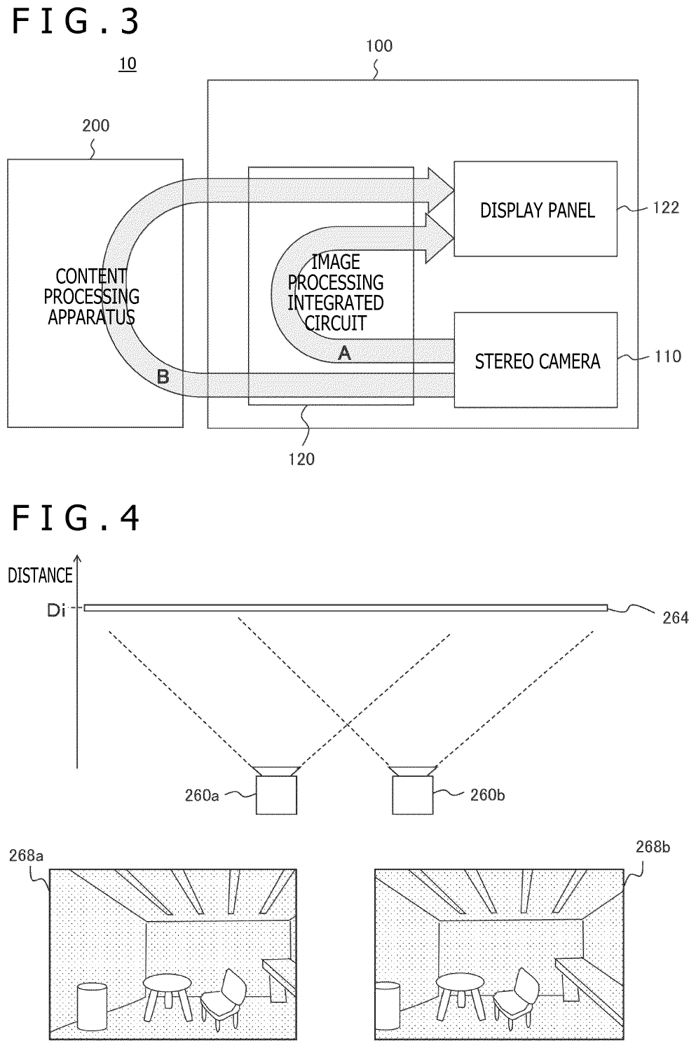

FIG. 3 schematically depicts a path of data in the image displaying system 10 according to the present embodiment. The head-mounted display 100 includes the stereo camera 110 and the display panel 122 as described above. The display panel 122 is a panel having a general display mechanism of a liquid crystal display, an organic electroluminescent (EL) display, or the like. In the present embodiment, the display panel 122 displays images for the left eye and the right eye, which configure a frame of a moving image, in left and right regions that are facing the left eye and the right eye of the user, respectively.

By forming a stereo image for the left eye and a stereo image for the right eye to have a parallax corresponding to the distance between the eyes, it is possible to cause the display target to be viewed stereoscopically. The display panel 122 may include two panels, i.e., a panel for the left eye and a panel for the right eye, placed side by side or may be a single panel that displays an image obtained by connecting an image for the left eye and an image for the right eye to each other in a left-right direction.

The head-mounted display 100 further includes an image processing integrated circuit 120. The image processing integrated circuit 120 is, for example, a system-on-chip on which various functional modules including a central processing unit (CPU) are mounted. It is to be noted that the head-mounted display 100 may include, in addition to the components described above, motion sensors such as a gyro sensor, an acceleration sensor, and an angular speed sensor, a main memory such as a dynamic random access memory (DRAM), an audio circuit for allowing the user to hear sounds, a peripheral equipment interface circuit for establishing connection with peripheral equipment, and so forth as described above. However, illustrations of them are omitted in FIG. 3.

In FIG. 3, two data paths used in a case where an image captured by the stereo camera 110 is to be displayed in the display are indicated by arrows. In a case where AR or MR is to be implemented, generally an image captured by the stereo camera 110 is taken into a main body that processes content, and the captured image and a virtual object are synthesized to generate a display image. Since, in the image displaying system 10 depicted in FIG. 3, the main body that processes the content is the content processing apparatus 200, an image captured by the stereo camera 110 is transmitted once to the content processing apparatus 200 via the image processing integrated circuit 120 as indicated by an arrow B.

Then, the captured image and a virtual object are synthesized, for example, and the resulting image is returned to the head-mounted display 100 and is then displayed on the display panel 122. On the other hand, in the case of the see-through mode, an image captured by the stereo camera 110 can be corrected to an image suitable for the display by the image processing integrated circuit 120 and can then be displayed on the display panel 122, as indicated by an arrow A. According to the path indicated by the arrow A, since the data transmission path significantly decreases in length in comparison with the path indicated by the arrow B, the length of time taken from image-capturing to displaying of the image can be reduced, and the power consumption required for the transmission can be reduced.

It is to be noted that the data path used in the see-through mode in the present embodiment is not limited to the data path indicated by the arrow A. In other words, the path indicated by the arrow B may be adopted such that an image captured by the stereo camera 110 is transmitted once to the content processing apparatus 200. Then, after the image is corrected to a display image by the content processing apparatus 200, the display image may be returned to the head-mounted display 100 and displayed thereon.

In either case, in the present embodiment, an image captured by the stereo camera 110 is preferably pipe-line processed sequentially in a unit smaller than one frame, such as a unit of a row, to minimize the length of time taken to display the image. This decreases the possibility that a screen image may be displayed with a delay with respect to a movement of the head and that the user may suffer from discomfort or motion sickness.

FIG. 4 is a view for explaining a relation between a three-dimensional space that forms a display world provided by the head-mounted display 100 and a display image generated from a captured image. It is to be noted that, in the following description, a captured image that has been converted into a display image is referred to as a see-through image irrespective of whether or not the current mode is the see-through mode. The upper part of FIG. 4 is an overhead view of a virtual three-dimensional space configured at the time of generation of a display image (such a virtual three-dimensional space is hereinafter referred to as a display world). Virtual cameras 260a and 260b are virtual rendering cameras for generating a display image and correspond to the left point of view and the right point of view of the user, respectively. The upward direction in FIG. 4 represents the depthwise direction (distance from the virtual cameras 260a and 260b).

See-through images 268a and 268b correspond to images of the situation of the inside of a room in front of the head-mounted display 100 which are captured by the stereo camera 110, and indicate display images for the left eye and the right eye for one frame. Needless to say, when the user changes the orientation of his or her face, the fields of view of the see-through images 268a and 268b also change. In order to generate the see-through images 268a and 268b, the head-mounted display 100 arranges a captured image 264, for example, at a predetermined distance Di in the display world.

More specifically, the head-mounted display 100 displays captured images 264 of the left point of view and the right point of view which are captured by the stereo camera 110, for example, on an inner plane of spheres of the radius Di centered at the respective virtual cameras 260a and 260b. Then, the head-mounted display 100 draws an image formed when the captured images 264 are viewed from the virtual cameras 260a and 260b, to generate the see-through image 268a for the left eye and the see-through image 268b for the right eye.

Consequently, the images 264 captured by the stereo camera 110 are converted into an image based on the point of view of the user who is viewing the display world. Further, the image of the same subject appears slightly to the right on the see-through image 268a for the left eye and appears slightly to the left on the see-through image 268b for the right eye. Since the captured images of the left point of view and the right point of view are originally captured with a parallax, the images of the subject also appear with various offset amounts on the see-through images 268a and 268b according to the actual position (distance) of the subject. With this, the user has a sense of distance from the images of the subject.

In such a manner, when the captured image 264 is displayed on a uniform virtual plane and an image viewed from a point of view corresponding to the user is used as a display image, even if a three-dimensional virtual world in which the arrangement and structure of a subject are accurately traced is not constructed, a captured image with a sense of depth can be displayed. Further, when the plane on which the captured image 264 is displayed (hereinafter referred to as a projection plane) is set to a spherical plane having a predetermined distance from the virtual camera 260, images of objects present within a supposed range without depending upon the direction can be displayed in uniform quality. As a result, it is possible to achieve both low latency and a sense of presence, with a low processing load. On the other hand, according to such a technique as described above, how an image is viewed changes depending upon the setting of the projection plane, possibly resulting in some kind of inconvenience depending upon a situation.

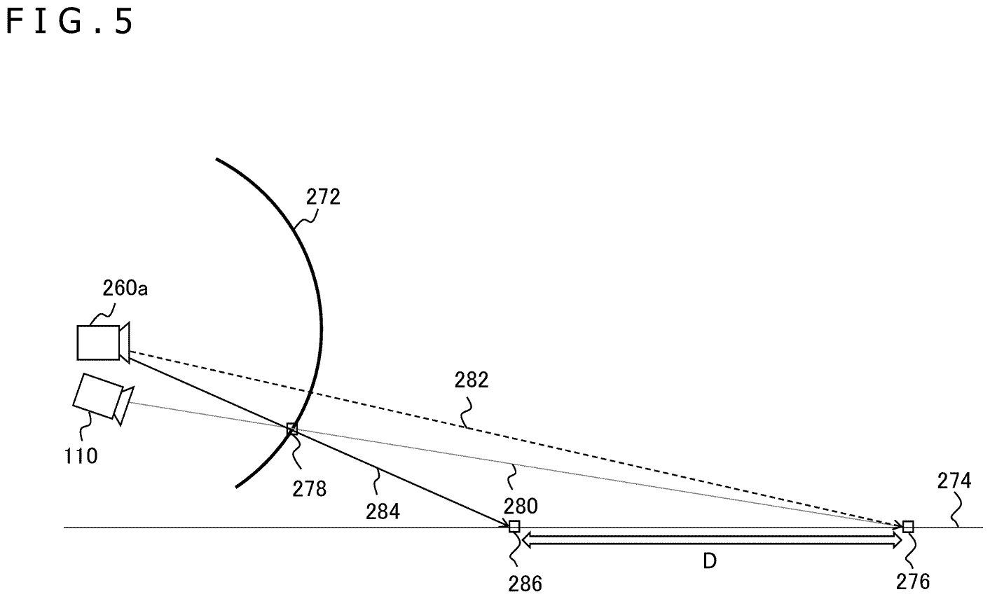

FIG. 5 is a view for explaining a problem that arises when a spherical plane is used as the projection plane. FIG. 5 depicts a situation when the three-dimensional space of the display world depicted in the upper part of FIG. 4 is viewed from a side thereof, and depicts the virtual camera 260a, which is one of the left and right virtual cameras, and a corresponding one of the stereo cameras 110. As described above, the display image indicates a situation in which an image captured by the stereo camera 110 is projected to a projection plane 272 and the projected imaged is viewed from the virtual camera 260a. In the present example, the projection plane 272 is, for example, the inner plane of a sphere being centered at the virtual camera 260 and having a radius of 2 m.

The virtual camera 260a and the stereo camera 110 move in conjunction with a movement of the head-mounted display 100 and hence a movement of the head of the user. When the floor 274 is included in the field of view of the stereo camera 110 in an indoor environment, for example, the image at a point 276 on the floor is projected to the projection plane 272 at a position 278 at which a line 280 of sight from the stereo camera 110 to the point 276 intersects with the projection plane 272. On the display image where the projected image is viewed from the virtual camera 260a, the image that should be displayed at the point 276 in the direction of a line 282 of sight is displayed in the direction of a line 284 of sight, and as a result, the user views the image as if the image were at a point 286 closer to the user than the point 276 by a distance D.

Further, as the point 276 is located farther, the position 278 at which the line 280 of sight from the stereo camera 110 intersects with the projection plane 272 comes higher on the projection plane 272. When the projected image is viewed from the virtual camera 260a, the image becomes taller due to a change that occurs in ordinary perspective projection and that is greater than a change of the image height with respect to the distance. Therefore, the user views the floor as if it were rising. Such a phenomenon as described above arises from the differences between the optical centers of the stereo camera 110 and the virtual camera 260a and between the optical directions thereof. Further, the unnaturalness tends to be emphasized in an image on a plane extending in the depthwise direction, such as the floor or the ceiling.

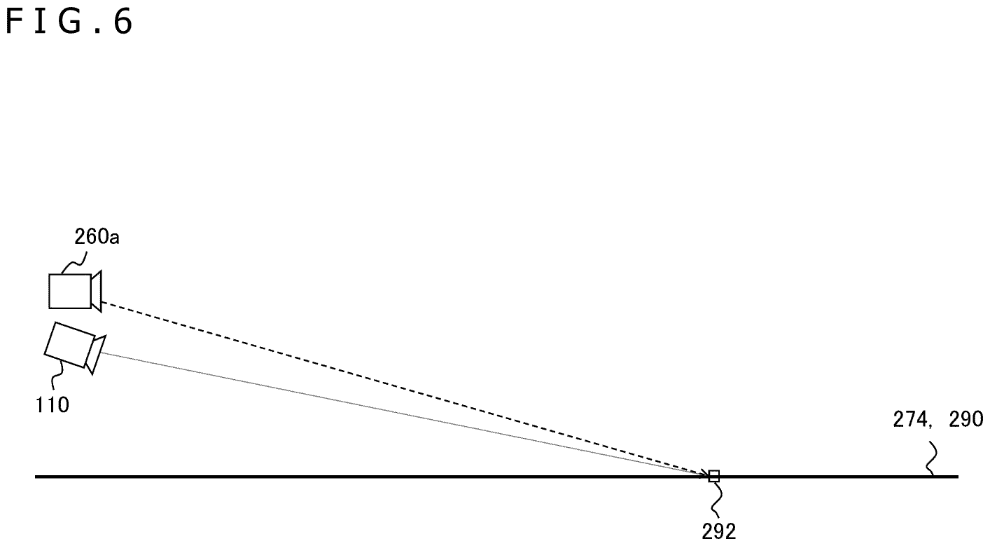

Hence, in the present embodiment, the projection plane of a captured image is changed according to a situation. FIG. 6 is a view for explaining an example of a projection plane set in the present embodiment. Although FIG. 6 depicts a situation in which a three-dimensional space of a display world is viewed from a side similarly to FIG. 5, FIG. 6 is different from FIG. 5 in that a projection plane 290 is a plane corresponding to an upper surface of the floor 274 in the real world. Here, the “corresponding plane” signifies a plane that is the same in terms of the position, range, and posture as viewed from the virtual camera 260a. It is to be noted that the projection plane 290 set in the display world is decided on the basis of the surface of the floor 274 recognized by the head-mounted display 100, and strict coincidence of the projection plane 290 with the actual upper surface of the floor 274 is not necessarily required.

When the projection plane 290 is made to correspond to the upper surface of the floor 274, the image at a point 292 in the image captured by the head-mounted display 100 is also displayed at the same position on the projection plane 290 in the display world. When the image is viewed from the virtual camera 260a, the point 292 can be seen at the same position in the same direction. In particular, on the display image, the image of the floor is displayed at the position of the floor and can visually be recognized as a natural floor without being recognized as being shrank on the front side or as being rising on the interior side. According to the present example, there is an effect that, not only unnaturalness of the appearance is prevented, but also such a situation is prevented that, in a case where computer graphics are synthesized according to an image of the floor, they look offset from each other because the image of the floor is not accurate or changes depending upon the point of view.

In this manner, the projection plane is adaptively set according to the priority given to an object depending upon a situation in which a captured image is displayed or according to a characteristic of the object, so that an image can be displayed with sufficient quality even by a simple process. In other words, the projection plane may variously be changed depending upon the situation and may be made to correspond to a surface of such an object as the ceiling other than the floor. Alternatively, an object and a plane set independently of the object may be combined as depicted in FIG. 5, or they may be switched in use. In a case where an object and an independently set plane are used, the size or shape of the plane may be changed.

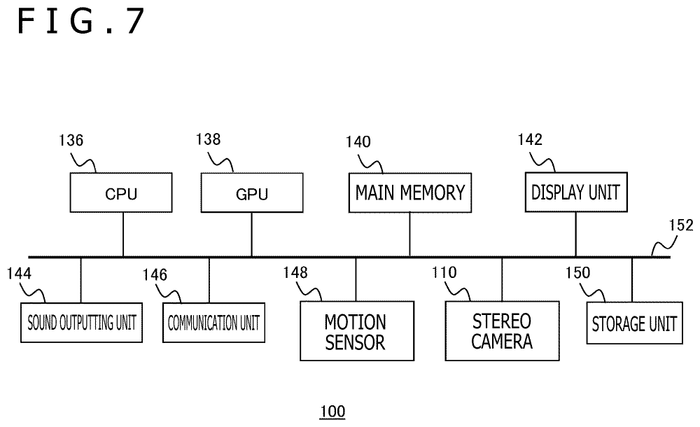

FIG. 7 depicts a configuration of an internal circuit of the head-mounted display 100. The head-mounted display 100 includes a CPU 136, a graphics processing unit (GPU) 138, a main memory 140, and a display unit 142. The components mentioned are connected to one another by a bus 152. A sound outputting unit 144, a communication unit 146, a motion sensor 148, the stereo camera 110, and a storage unit 150 are further connected to the bus 152. It is to be noted that the configuration of the bus 152 is not limited to a particular one, and the bus 152 may include, for example, multiple buses connected to one another by an interface.

The CPU 136 controls the overall head-mounted display 100 by executing an operating system stored in the storage unit 150. Further, the CPU 136 executes various programs read out from the storage unit 150 and loaded into the main memory 140 or downloaded through the communication unit 146. The GPU 138 performs drawing and correction of an image according to a drawing command from the CPU 136. The main memory 140 includes a random access memory (RAM) and stores programs and data necessary for processing.

The display unit 142 includes the display panel 122 depicted in FIG. 3 and displays an image in front of the eyes of the user wearing the head-mounted display 100. The sound outputting unit 144 includes speakers or earphones provided at positions corresponding to the ears of the user when the head-mounted display 100 is worn, and allows the user to hear sounds.

The communication unit 146 is an interface for transferring data to and from the content processing apparatus 200 and performs communication by a known wireless communication technology such as Bluetooth (registered trademark) or a wired communication technology. The motion sensor 148 includes a gyro sensor, an acceleration sensor, an angular speed sensor, and so forth and acquires an inclination, an acceleration, an angular speed, and so forth of the head-mounted display 100. The head-mounted display 100 includes a pair of video cameras that capture an image of a surrounding actual space from left and right points of view as depicted in FIG. 1. The storage unit 150 includes a storage such as a read only memory (ROM).

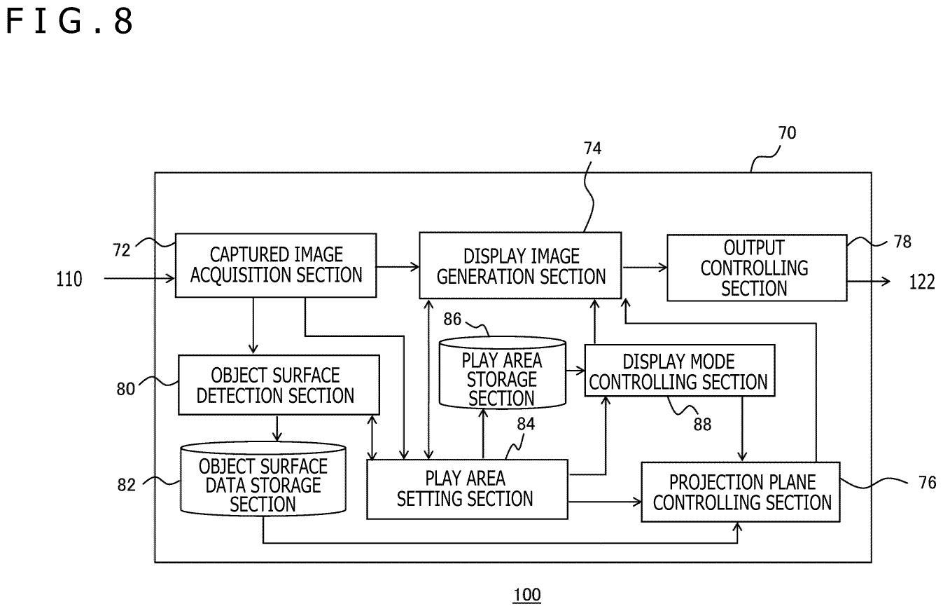

FIG. 8 depicts a configuration of functional blocks of the head-mounted display 100 in the present embodiment. The functional blocks depicted in FIG. 8 can be implemented in terms of hardware by the circuit configuration depicted in FIG. 7 and in terms of software by a program that is loaded from the storage unit 150 into the main memory 140 and that performs various functions such as a data inputting function, a data retaining function, an image processing function, and a communication function. Accordingly, it can be understood by those skilled in the art that these functional blocks can variously be implemented only by hardware, only by software, or by combination of hardware and software and are not limited to any of them.

Further, the head-mounted display 100 may have functions other than those depicted in FIG. 8. Moreover, some of the functional blocks depicted in FIG. 8 may be included in the content processing apparatus 200. In the head-mounted display 100, an image processing unit 70 can be implemented by the image processing integrated circuit 120 of FIG. 3.

In the head-mounted display 100, the image processing unit 70 includes a captured image acquisition section 72 that acquires data of a captured image, a projection plane controlling section 76 that controls the projection plane of a captured image, a display image generation section 74 that generates data of a display image, and an output controlling section 78 that outputs the data of the display image. The image processing unit further includes an object surface detection section that detects the surface of a real object, an object surface data storage section 82 that stores data of an environmental map, a play area setting section 84 that sets a play area, a play area storage section 86 that stores data of the play area, and a display mode controlling section 88 that controls the display mode such as the see-through mode.

The captured image acquisition section 72 acquires data of a captured image at a predetermined frame rate from the stereo camera 110. The projection plane controlling section 76 changes the projection plane of a captured image according to a situation in a period in which a display image including the captured image is generated. The projection plane controlling section 76 decides the projection plane, for example, according to a purpose of displaying the captured image or a target to which the user pays attention. As an example, the projection plane controlling section 76 makes the projection plane correspond to the floor surface as depicted in FIG. 6 in a period in which a play area is being set, or when it becomes necessary to indicate a play area during execution of a game.

This decreases the possibility that the image of the floor may be displayed unnaturally or that graphics indicative of a play area may be displayed in such a manner as to be detached from the image of the floor. In the above example, the image of the floor is made to look natural by changing the projection plane or is synthesized with graphics with high accuracy, but this is not limited to the floor and may be any object such as the ceiling, controller, or furniture. Further, the projection plane decided for such a purpose as described above is not limited to that corresponding to the object itself and may be a virtual plane set independently of the object.

Information regarding optimum projection planes in various possible situations is determined theoretically or by an experiment and is stored into an internal memory of the projection plane controlling section 76 in advance. During the operation, the projection plane controlling section 76 specifies a projection plane made to correspond to the situation that has occurred, and notifies the display image generation section 74 of the specified projection plane. It is to be noted that, in a case where the projection plane is to be made to correspond to an object surface, the projection plane controlling section 76 designates at least any one of a position, a shape, and a posture of the projection plane by using a result of object detection. Alternatively, prescribed values of the data may be prepared for individual objects in advance, and the projection plane controlling section 76 may designate a projection plane by using the prescribed values.

The display image generation section 74 projects a captured image to the projection plane the notification of which has been received from the projection plane controlling section 76, in a period in which the captured image is included in the display in the see-through mode or the like, and generates, as a display image, an image displayed when the projected image is viewed from a virtual camera. At this time, the display image generation section 74 acquires the position and posture of the head-mounted display 100 at a predetermined rate on the basis of a result of analysis of the captured image and a measurement value of the motion sensor and decides a position and posture of the virtual camera according to the acquired position and posture of the head-mounted display 100.

The display image generation section 74 may superimpose computer graphics on the see-through image generated in such a manner, to present various kinds of information or generate a content image of AR, MR, or the like. Further, the display image generation section 74 may generate a content image of VR or the like that does not include a captured image. Especially in a case where a content image is to be generated, the content processing apparatus 200 may perform at least some of the functions.

The output controlling section 78 acquires data of a display image at a predetermined frame rate from the display image generation section 74, performs a process necessary for displaying for the acquired data, and outputs the resulting data to the display panel 122. The display image includes a pair of images for the left eye and the right eye. The output controlling section 78 may correct the display image in a direction in which distortion aberration and chromatic aberration are canceled, such that, when the display image is viewed through the eyepieces, an image free from any distortion is visually recognized. Further, the output controlling section 78 may perform various data conversions corresponding to the display panel 122.

The object surface detection section 80 detects a surface of a real object present around the user in the real world. For example, the object surface detection section 80 generates data of an environmental map that represents a distribution of feature points on the surface of an object in a three-dimensional space. In this case, the object surface detection section 80 sequentially acquires data of a captured image from the captured image acquisition section 72 and executes Visual SLAM described above to generate data of an environmental map. Visual SLAM is a technology of acquiring, on the basis of corresponding points extracted from stereo images, coordinates of three-dimensional positions of the feature points on the object surface and tracing the feature points in frames of a time series order to acquire the position and posture of the stereo camera 110 and an environmental map in parallel. However, the detection method performed by the object surface detection section 80 and the representation form of a result of the detection are not limited to particular ones.

The object surface data storage section 82 stores data indicative of a result of the detection by the object surface detection section 80, e.g., data of an environmental map. The projection plane controlling section 76 acquires the position and structure of the surface of an object to which the projection plane is to be made to correspond, from object surface data, and decides a projection plane appropriately according to the acquired position and structure. The play area setting section 84 sets a play area before execution of an application of a game or the like. The play area setting section 84 first cooperates with the object surface detection section 80 to specify surfaces of a piece of furniture, a wall, and so forth present around the user and decides, as a play area, the range of the floor surface within which there is no possibility that the floor surface may collide with the specified surfaces.

Further, the play area setting section 84 may cause the display image generation section 74 to generate and display a display image in which graphics representative of the range and boundary of the play area decided once are superimposed on a see-through image, and may accept an editing operation of the play area by the user. Then, the play area setting section 84 acquires the details of an operation made by the user through an inputting device, which is not depicted, or the like and changes the shape of the play area according to the details of the operation. The play area storage section 86 stores data of the play area decided in such a manner.

The display mode controlling section 88 controls the display mode of the head-mounted display 100. Such display modes are roughly classified into the see-through mode and a content image displaying mode. In consideration of a situation (mode) in which an image captured by the stereo camera 110 is included in the display, the display modes are further subdivided as follow.
a. Immediately after the user puts on the head-mounted display or in a period in which content is not executed
b. In a period in which an editing operation of a play area is performed
c. When a warning relating to deviation from a play area is given to the user during execution of content such as a VR game
d. In a case where the content image is that of AR or MR

In the situation “a,” the display image generation section 74 uses only a see-through image as the display image to support the user to check the situation of the surroundings or pick up the controller. Alternatively, the display image generation section 74 may superimpose graphics indicative of the position of the controller, on the see-through image in order for the user to easily find the controller.

In the situation of “b,” the display image generation section 74 superimposes graphics representing the boundary of the play area, on a see-through image to generate a display image. With this, the user can check the range of the play area in the real world, and a modification operation for the graphics can be accepted from the user, enabling editing of the play area.

The situation of “c” occurs when, during execution of a VR game or the like, the user comes nearer to the boundary of the play area by a fixed distance or more or goes out of the play area. In this case, the display image generation section 74 switches the display, for example, from the original content image to the see-through image and superimposes graphics representative of the boundary of the play area on the see-through image. This makes it possible for the user to check the own position, move to a safe place, and then restart the game. In the situation of “d,” the display image generation section 74 generates a content image in which a virtual object and the see-through image are synthesized such that the virtual object coincides with an image of a subject on the see-through image.

The display mode controlling section 88 acquires signals relating to a cause of such situations as described above, from a head-mounted display wearing sensor, which is not depicted, an inputting device, the play area setting section 84, the content processing apparatus 200, and so forth. Then, the display mode controlling section 88 appropriately determines a start or an end of any of various modes and requests the display image generation section 74 to generate a corresponding display image. Alternatively, the display mode controlling section 88 may trace the position of the user, collate the position with data of the play area to determine a start or an end of the situation “c,” and request the display image generation section 74 to generate a corresponding display image. The position information regarding the user can be acquired on the basis of a result of analysis of the image captured by the stereo camera 110, a measurement value of the motion sensor, or the like.

The projection plane controlling section 76 changes the projection plane of a captured image at a timing of a start or an end of each mode determined by the display mode controlling section 88, as necessary. It is to be noted that the projection plane controlling section 76 may change the projection plane in all modes described above or only in some of the modes. Further, the situation in which the projection plane is to be changed in the present embodiment is not limited to the display modes described above.

For example, when the target to which the user pays attention changes, the projection plane may be switched according to the target object. The target to which the user pays attention may be an object at the center of the display image or may precisely be specified by a gaze point detector. Further, in a case where AR or MR is to be implemented, a real object in the proximity of a main virtual object may be estimated as the target to which the user pays attention. When a request for switching of the projection plane is received from the projection plane controlling section 76, the display image generation section 74 may provide a period in which an animation is displayed in such a manner that switching of the projection plane is gradually reflected on the display image. By providing such a transition period as described above, the discomfort due to a sudden change of the appearance of an image can be moderated.

Alternatively, the display image generation section 74 may recognize a timing at which the user blinks, and change the projection plane at the timing. To detect the timing described above, a gaze point detector, which is not depicted, provided in the head-mounted display 100 can be used. The gaze point detector is a general device that emits reference light such as infrared rays to an eye of the user, captures an image of reflected light from the eye, and specifies the position to which the line of sight is directed, on the basis of the movement of the eyeball. In this case, the display image generation section 74 detects a timing at which the eyelid begins to close, on the basis of the captured image of the eyeball of the user, and switches the projection plane within a period of time generally required for the blink from the detected timing. With this, the instant at which the appearance of the image changes also becomes less likely to be visually recognized.

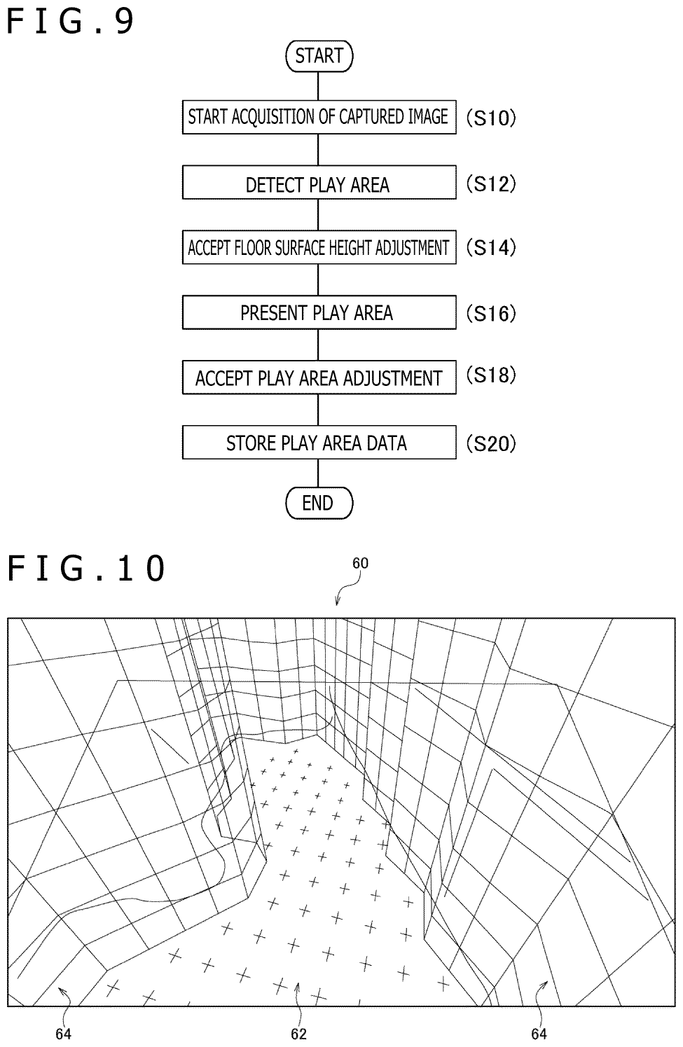

Next, a process of setting a play area, which is a representative situation in which the projection plane is made to correspond to the floor, will be described. FIG. 9 is a flow chart depicting a processing procedure for setting a play area by the play area setting section 84. This flowchart is started when the user puts on the head-mounted display 100 and sends a request for initial setting or re-setting of a play area. In response to the start of the processing, the play area setting section 84 starts acquisition of an image captured by the stereo camera 110 (S10).

Then, the play area setting section 84 cooperates with the object surface detection section 80 to detect a play area (S12). In particular, the play area setting section 84 first causes the display panel 122 to display a see-through image via the display image generation section 74 and present a message for prompting the user to look around. When the user looks around or moves around while looking at the see-through image, a captured image including the floor, furniture, walls, and so forth is acquired. The object surface detection section 80 detects surfaces of real objects by using the captured image, to generate data of an environmental map and so forth.

The play area setting section 84 detects the floor by specifying, on the basis of the correspondence between the output of the acceleration sensor provided in the head-mounted display 100 and the frame of the captured image, a surface perpendicular to the force of gravity from among the detected surfaces of the objects. Further, the play area setting section 84 specifies surfaces of obstacles present around the user, such as furniture and walls, with reference to the floor surface. The play area setting section 84 sets a boundary surface of a play area on the inner side of a region surrounded by the surfaces of the obstacles. The display image generation section 74 may cause a see-through image to be displayed all the time in the processing of S12.

Then, the play area setting section 84 accepts an operation for adjusting the height of the floor surface, from the user (S14). At this time, the display image generation section 74 clearly indicates the height of the floor surface detected in S12, by superimposing an object indicative of the floor surface, on the see-through image. When the user moves the object upwardly or downwardly as necessary, the play area setting section 84 accepts the operation and updates the height of the floor surface on the data.

Then, the play area setting section 84 presents a situation of the play area in which the height of the floor surface has been updated as necessary, to the user (S16). At this time, the display image generation section 74 generates a display image in which objects indicative of the range of the floor, which is the play area, and indicative of the boundary surface of the range are superimposed on the see-through image, and causes the generated display image to be displayed. Then, the play area setting section 84 accepts an operation for adjusting the play area, from the user (S18). For example, the play area setting section 84 accepts an operation for expanding, narrowing, or deforming the object indicative of the play area. When the user performs such an adjustment operation as described above, the play area setting section 84 accepts the operation, modifies the data of the play area, and stores the modified data into the play area storage section 86 (S20).

FIG. 10 exemplifies the object in the play area presented in S16 of FIG. 9. A play area object 60 includes a floor surface portion 62 and a boundary surface portion 64. The floor surface portion 62 represents the range of the play area on the floor surface. The boundary surface portion 64 represents the boundary surface of the play area and includes, for example, a plane perpendicular to the floor surface. The floor surface portion 62 and the boundary surface portion 64 are represented, for example, as objects of semi-transparent lattice shapes.

The display image generation section 74, in practice, superimposes such a play area object 60 as depicted in FIG. 10 on the see-through image in such a manner that the play area object 60 and the see-through image are synthesized, to form a display image. When the operation for adjusting the height of the floor surface is accepted in S14 of FIG. 9, the display image generation section 74 also superimposes the object indicative of the floor surface on the see-through image to form a display image. In the situations, the display image generation section 74 arranges the object to be displayed in a superimposed manner in the three-dimensional display world (world coordinate system) and draws the object, while it draws the see-through image on the basis of the captured image projected to the projection plane.

Hence, if the projection plane is not appropriate, then the captured image of the floor surface and the object may not be displayed in an overlapped manner. Consequently, it may take an extra time for the user to perform various adjustment, or the user may fail in accurate adjustment. In the present embodiment, at least in a period in which the floor surface is set to an adjustment target, or in a period, other than the abovementioned period, in which it is apparent that the user pays attention to the floor, the projection plane is made to correspond to the floor. Consequently, the image is displayed accurately, and the user can perform adjustment easily and accurately without the discomfort.

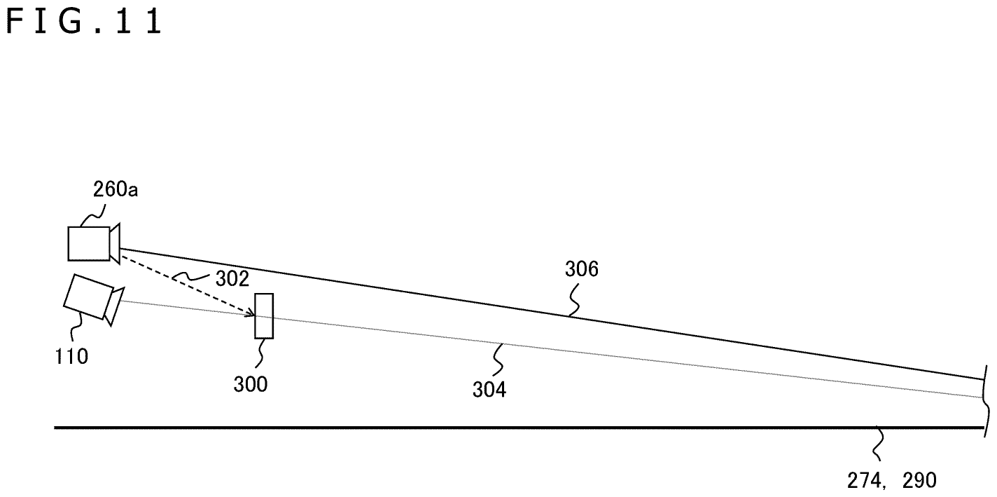

On the other hand, it is conceivable that, in a case where the projection plane is made to correspond only to the floor, adverse effects can be caused on images of objects other than the floor. FIG. 11 is a view for explaining a program that arises in a case where the projection plane is made to correspond only to the floor in the present embodiment. FIG. 11 depicts a situation when a three-dimensional space of the display world is viewed from a side similarly to FIG. 6, and the projection plane 290 is made to correspond to the upper surface of the floor 274 in FIG. 11. In the present example, it is assumed that an object 300 is present in the proximity of the head-mounted display 100 and hence the stereo camera 110. The object 300 is, for example, a game controller grasped by the user.

When the projection plane 290 is made to correspond only to the floor 274, the image of the object 300 is projected far away beyond a line 304 of sight as viewed from the stereo camera 110. In a case where the projected image is viewed from the virtual camera 260a, a display image is undesirably generated such that the image that should be displayed in the direction of a line 302 of sight is displayed far away beyond a line 306 of sight. Such a divergence increases as the distance from the object 300 to the stereo camera 110 decreases and as the height position of the object 300 is above the field of view.

For example, in a case where the user intends to pick up the controller or a figure indicative of the controller is to be displayed in a superimposed manner on a see-through image in the situation “a” described above, it may be difficult for the user to recognize a distance to the controller, or the figure and the image may be offset from each other, leading to an extra time. Hence, the projection plane controlling section 76 combines multiple different planes such that, even if multiple objects that are different in position or characteristic from one another are present, they are displayed with minimized divergence.

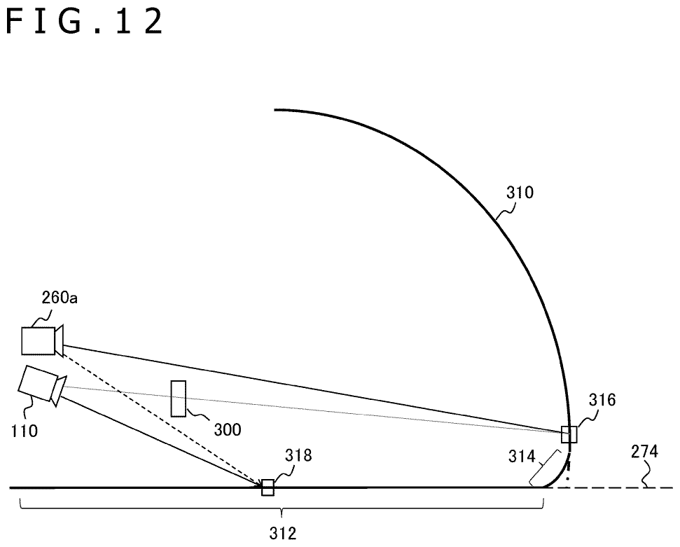

FIG. 12 is a view for explaining a mode in which multiple different planes are combined to make a projection plane. FIG. 12 depicts a situation when a three-dimensional space of a display world is viewed from a side similarly to FIG. 11. In addition, in FIG. 12, the projection plane includes a portion 312 that is made to correspond to the upper surface of the floor 274 and an inner plane portion of a sphere 310 as indicated by a thick line in FIG. 12. The inner plane portion of the sphere 310 is a virtual plane centered at the virtual camera 260a, similarly to that depicted in FIG. 5. The portion 312, which corresponds to the floor 274 and is made to correspond to the projection plane, is a region on the inner side of the sphere 310. As a result, the projection plane becomes a continuous plane including a flat plane and a spherical inner plane combined with each other.

A joining portion 314 between the flat plane and the spherical inner plane may be a curved plane to connect the flat plane and the spherical inner plane smoothly and to prevent the angle from changing discontinuously and producing artifacts in the image. According to such a projection plane as described above, the image of the object 300 in the image captured by the stereo camera 110 is projected to the inner plane portion of the sphere 310 in the proximity of a point 316. In the display image obtained when the projected image is viewed from the virtual camera 260a, the apparent position of the image of the object 300 is displayed relatively near the actual position of the object 300 in comparison with that in the case of FIG. 11.

Simultaneously, the image at the portion 312 of the floor 274 in the captured image where at least the projection plane corresponds to the floor 274 is displayed without deformation in the display image. For example, the image at a point 318 on the floor 274 is displayed as if it were at the same position when viewed from the virtual camera 260a. The floor surface and the spherical plane are combined and formed as the projection plane in such a manner, so that it is possible to display the image of the floor appropriately and bring the apparent position of the image of the object 300 closer to the actual position thereof. Although, in the present example, two planes are combined in correspondence with two objects, the number of kinds of planes to be combined may be three or more.

In a case where the image of the floor is given a higher priority at the time of setting of a play area or the like, when the projection plane controlling section 76 increases the radius of the sphere 310 to 5.0 m or the like, the range of the floor that is displayed accurately can be increased. However, in this case, as the radius increases, the apparent position of the image of the object 300 becomes farther away from the actual position of the object 300. Supposing that the object 300 is the controller, in a situation in which the controller is held by the user or the position of the controller is represented by a figure, the image of the controller is given a higher priority.

In this case, the projection plane controlling section 76 can reduce, in consideration of the range in which the controller is present with high possibility, the radius of the sphere 310 to 0.8 m or the like, thereby preventing the apparent position of the image of the controller from diverging from the actual position. In a situation in which the importance of the image of the floor is low as described above, the projection plane controlling section 76 may use only the inner plane of the sphere 310 while excluding the portion 312, which is made to correspond to the floor 274, from the projection plane.

The projection plane controlling section 76 may retain therein data being set for each object and regarding the range in which the corresponding object is present with high possibility, and change the radius of the sphere of the projection plane according to the characteristic or the presence probability of an object having high priority. Further, the projection plane controlling section 76 may acquire position information regarding objects in a captured image and decide a radius of the sphere according to the position information. For example, the projection plane controlling section 76 may acquire the actual position of an object on the basis of data of an environmental map generated by the object surface detection section 80 and change the radius of the sphere according to the actual position of the object. It is to be noted that the shape of the projection plane formed virtually in this manner is not limited to the sphere, and may be a flat plane, a cylinder, or the like or be a combination of two or more of them.

In a case where the projection plane is to be made to correspond to an object itself such as the floor, the projection plane controlling section 76 basically determines a surface that is actually detected on the basis of an environmental map or the like, as the projection plane. However, the environmental map depicts a distribution of feature points in a three-dimensional space, and therefore, similar objects may be present. In such a case, there is the possibility that a surface of an object may be detected in error. Therefore, the projection plane controlling section 76 may retain therein the data being set for each object and regarding the range in which the corresponding object is present with high possibility, and in a case where the detected surface of an object is outside the abovementioned range, the position of the surface may be adjusted and optimized as much as possible.

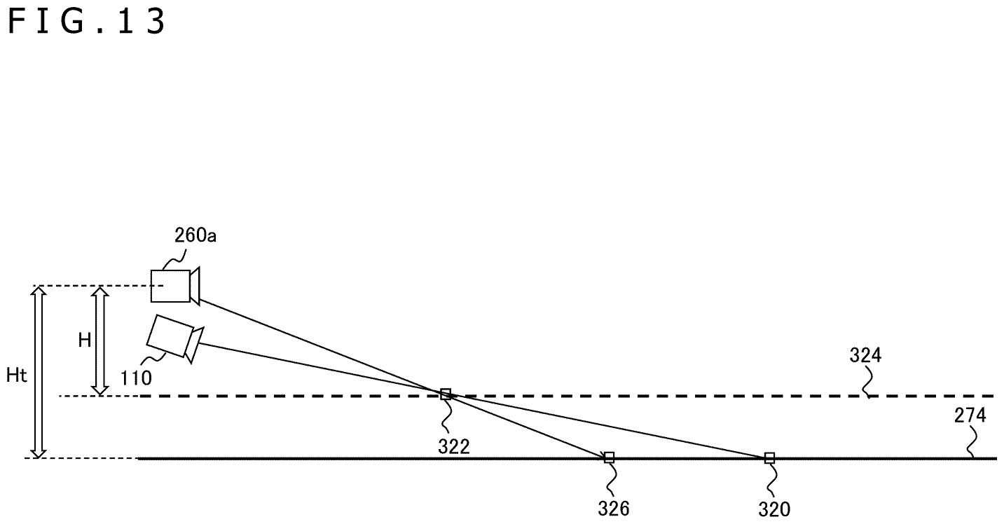

FIG. 13 is a view for explaining a mode in which the projection plane controlling section 76 adjusts the height of the floor surface to which the projection plane is to be made to correspond. As in FIG. 6, it is assumed in FIG. 13 that an image of a floor 274 including a point 320 is captured by the stereo camera 110. On the other hand, if a plane 324 of a different height is detected as the floor in error on the basis of an environmental map or the like, then the image at the point 320 is projected to a point 322 on the plane 324. On a display image obtained when the projected image is viewed from the virtual camera 260a, the image at the point 320 is displayed as if the image were at a point 326.

When the user adjusts the height of the floor in the process of setting a play area as described above, the original position of the floor 274 is acquired. In particular, by an adjustment operation made by the user, the distance from the reference point of the head-mounted display 100 (in FIG. 13, the center of the virtual camera 260a) to the floor surface is modified from a distance H which has been detected first to an actual distance Ht. However, if the detected distance H is excessively displaced from the true value Ht, then the image becomes unnatural even on the screen for accepting the height adjustment of the floor, and thus, it may take an extra time to perform adjustment, or it may become difficult to perform accurate adjustment.

For example, in a case where a table having a great area is recognized as the floor in error, the distance H is several tens cm. In a display image obtained when the captured image projected to the plane 324 at the above height is viewed from the virtual camera 260a, an image of the floor that diverges from the perspective projection and that is not realistic is sometimes displayed. Hence, the projection plane controlling section 76 provides a lower limit Hu to the distance H to the plane 324 detected as the floor and adjusts, in the case where H<Hu, the distance H such that H=Hu. In other words, the projection plane controlling section 76 guarantees that the distance H to the floor is equal to or greater than Hu.

As an example, in a case where the lower limit Hu of the distance H is set to 0.5 m, if the distance H of the floor surface detected first is 0.4 m, then the projection plane controlling section 76 decreases the height of the concerned surface by 0.1 m to adjust the distance H such that H=0.5 m. By such adjustment as described above, not only on the screen for accepting height adjustment of the floor by the user, but also in any other situation, the image can be displayed as a horizontal plane that can be recognized as the floor.

As described above, such adjustment can be applied not only to the floor surface but also to other objects such as the ceiling or a wall. In this case, the projection plane controlling section 76 retains, for each of objects to which the projection plane is assumed to be made to correspond, setting data regarding an appropriate range of the position, that is, at least either an upper limit or a lower limit of the range, according to the range in which the corresponding object is present with a high probability. Then, the projection plane controlling section 76 adjusts the setting data such that the actually detected position is included in its appropriate range, and then determines the adjusted data as the projection plane.

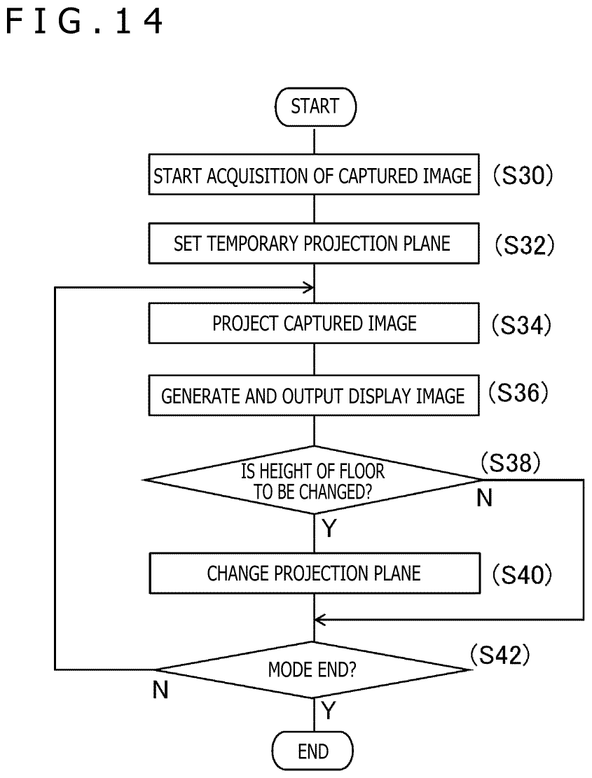

FIG. 14 is a flow chart depicting a procedure for displaying a see-through image in a period in which the floor surface is detected and adjusted. This flow chart is carried out, for example, in parallel to the process of setting a play area as depicted in FIG. 9. First, the display image generation section 74 starts acquisition of an image captured by the stereo camera 110 (S30). In an initial stage, since the floor surface is not detected, the projection plane controlling section 76 sets a temporary projection plane determined in advance (S32). For example, in a case where the upper surface of the floor 274 and the inner plane of the sphere 310 are combined to form a projection plane as depicted in FIG. 12, the radius of the sphere 310 is set to 5.0 m, and the distance H between the head-mounted display 100 and the floor is set to 1.5 m.

By such setting, an image of the floor up to a distance of approximately 5.0 m is displayed with less error, while an image of an object present above the floor can be displayed as a foreground to the utmost. The display image generation section 74 projects the captured image to the temporary projection plane (S34), generates a display image representative of a state in which the projected image is viewed from the virtual camera, and outputs the generated display image to the display panel via the output controlling section 78 (S36). Unless there is the necessity to change the set value of the height of the floor, the display image generation section 74 continues to project an image to the same projection plane and generate a display image for succeeding frames (N in S38, N in S42, S34, and S36).

In this period, when the user appropriately looks around the surrounding space, frames of various captured images are collected. The object surface detection section 80 uses the captured images to detect surfaces of objects present in the real world. If the play area setting section 84 specifies the floor from the detected surfaces and needs to update the set value of the height of the floor (Y in S38), then the projection plane controlling section 76 changes the projection plane accordingly (S40). For example, the projection plane controlling section 76 keeps the radius of the sphere configuring the projection plane, at 5.0 m, and changes only the set value of the height of the floor to be made to correspond to the projection plane.

The display image generation section 74 projects the captured image to the changed projection plane to generate a display image and outputs the display image (N in S42, S34, and S36). This increases the accuracy of the image of the floor surface. In this state, the play area setting section 84 superimposes an object representative of a range of a play area decided by using a result of detection of the object surface, on the see-through image, to prompt the user to perform height adjustment of the floor surface. When the user performs an adjustment operation and the necessity of changing the set value of the height of the floor newly arises (Y in S38), the projection plane controlling section 76 changes the projection plane according to the result of the adjustment (S40).

Also in this case, it is sufficient if the projection plane controlling section 76 changes only the set value of the height of the floor to be made to correspond to the projection plane, without changing the radius of the sphere configuring the projection plane. With this, the height of the floor surface configuring the play area is set accurately, and the image of the floor is also displayed more accurately. It is to be noted that, when the projection plane is changed in S40, the display image generation section 74 preferably displays a state of transition by an animation over multiple frames as described above, for example, thereby preventing the image of the floor from changing suddenly.

Further, in a process of detecting an object surface, it is conceivable that the height of the floor to be detected may fluctuate. The projection plane controlling section 76 may change the setting of the projection plane according to the fluctuation. Meanwhile, the display image generation section 74 preferably suppresses unnatural fluctuation of the image of the floor by moderately changing the projection plane according to convolution calculation or the like and not causing the change of the projection to be reflected immediately. The processing of S34 to S40 is repeated until the display mode controlling section 88 determines an end of the display mode in the process of setting a play area (N in S42), and when the end of the display mode is determined, the displaying process in the mode is ended (Y in S42).

According to the present embodiment described above, an image captured by the camera provided in the head-mounted display is displayed on a projection plane that is changed according to a situation, and a display image in a state in which the image is viewed from a virtual camera is generated. Accordingly, the captured image can be displayed with low latency by a simple process, and an image of a subject that is important in each situation can preferentially be displayed stereoscopically with high accuracy. Further, also in a case where computer graphics are to be displayed in a superimposed manner on the captured image, they can be displayed without divergence therebetween.

For example, in setting of a play area, the projection plane is made to correspond to the floor surface, and therefore, an image of the floor free from the discomfort can be displayed, and it becomes easy to synthesize graphics representative of a play area and the image of the floor. Thus, the user can easily perform adjustment of the height of the floor or the play area with high accuracy. Further, the shape, position, and size of the projection plane are made variable, so that the projection plane can be adapted with high flexibility to a fine situation in regard to whether or not a subject has been detected, the position that has been subjected to the detection or the adjustment, the range in which the presence probability is high, and so forth. Hence, both the low latency and the accuracy are achieved, and a user experience of high quality as a whole can be provided.

The present disclosure has been described in conjunction with the embodiment. The embodiment is exemplary, and it can be understood by those skilled in the art that various modifications can be made in the combinations of the components and the processes in the embodiment and that such modifications also fall within the scope of the present disclosure.

What is claimed is:

1. A head-mounted display comprising:
a captured image acquisition section that acquires data of an image captured by a camera mounted on the head-mounted display;
a display image generation section that displays the captured image on a projection plane set in a virtual three-dimensional space as a display target and draws an image obtained when the captured image is viewed from a virtual camera, to generate a display image including the captured image;
a projection plane controlling section that changes the projection plane according to a situation; and
an outputting section that outputs the display image.

2. The head-mounted display according to claim 1, wherein the projection plane controlling section makes, in a predetermined situation, at least part of the projection plane correspond to a surface of an object present in a real world.

3. The head-mounted display according to claim 1, wherein the projection plane controlling section sets, in a predetermined situation, the projection plane that includes a plane corresponding to a surface of an object present in a real world and a plane set independently of the object.

4. The head-mounted display according to claim 1, wherein the projection plane controlling section makes, in a predetermined situation, at least part of the projection plane correspond to a floor surface in a real world.

5. The head-mounted display according to claim 4, further comprising:
a play area setting section that sets a play area defining a movable range of a user, wherein
the display image generation section superimposes an object indicative of the play area on the display image including the captured image displayed on the projection plane.

6. The head-mounted display according to claim 2, further comprising:
an object surface detection section that detects the surface of the object on a basis of the captured image, wherein
the projection plane controlling section decides a portion of the projection plane to be made to correspond to the surface of the object, on a basis of a result of the detection of the surface of the object.

7. The head-mounted display according to claim 6, wherein the projection plane controlling section sets the portion of the projection plane to be made to correspond to the surface of the object, on a basis of a prescribed value associated with the object, in a period in which the surface of the object has not been detected.

8. The head-mounted display according to claim 6, wherein the projection plane controlling section adjusts a position of the surface of the object indicated by a result of the detection, such that the position of the surface falls within an appropriate range associated with the object, and then decides the projection plane.

9. The head-mounted display according to claim 1, wherein the projection plane controlling section uses at least part of the projection plane as an inner plane of a virtual sphere and changes a radius of the sphere according to a situation.

10. The head-mounted display according to claim 9, wherein the projection plane controlling section decides the radius of the sphere according to a characteristic of an object having a high priority among multiple objects included in the captured image.

11. The head-mounted display according to claim 1, wherein the display image generation section provides a transition period in which, when the projection plane is to be switched, the switching is gradually reflected on the display image.

12. The head-mounted display according to claim 1, wherein the display image generation section detects a start of a blink of a user on a basis of a captured image of an eyeball of the user and changes the projection plane while the user blinks.

13. An image displaying method performed by a head-mounted display, the method comprising:
acquiring data of an image captured by a camera mounted on the head-mounted display;
displaying the captured image on a projection plane set in a virtual three-dimensional space as a display target and drawing an image obtained when the captured image is viewed from a virtual camera, to generate a display image including the captured image;
changing the projection plane according to a situation; and
outputting data of the display image to a display panel.

14. A computer program for a computer included in a head-mounted display, comprising:
by a captured image acquisition section, acquiring data of an image captured by a camera mounted on the head-mounted display;
by a display image generation section, displaying the captured image on a projection plane set in a virtual three-dimensional space as a display target and drawing an image obtained when the captured image is viewed from a virtual camera, to generate a display image including the captured image;
by a projection plane controlling section, changing the projection plane according to a situation; and
by an outputting section, outputting data of the display image to a display panel.
